(19) United States
(12) Patent Application Publication
(10) Pub. No.: US 2016/0056535 A1
(43) Pub. Date: Feb. 25, 2016

(54) MULTIBAND ANTENNA

(71) Applicant: Samsung Electronics Co., Ltd., Suwon-si (KR)

(72) Inventors: Min SAKONG, Gumi-si (KR); Dong Ryul SHIN, Daegu (KR); Eun Jin LEE, Gumi-si (KR); Joon Bo PARK, Busan (KR); Byung Chan JANG, Gumi-si (KR); Jin Woo JUNG, Seoul (KR)

(21) Appl. No.: 14/832,353

(22) Filed: Aug. 21, 2015

(30) Foreign Application Priority Data
Aug. 22, 2014 (KR) 10-2014-0109437

(51) Int. Cl. H01Q 1/50; H01Q 1/38; H01Q 9/26

(52) U.S. Cl. CPC H01Q 1/50; H01Q 9/26; H01Q 1/38

(57) ABSTRACT

A multiband antenna is provided. The multiband antenna includes a feeding unit, a first radiator including a first path, a second radiator including a second path sharing at least a portion of the first path, a current dispersion path extending to a ground from one end of the first path, and a switch configured to open and short-circuit the current dispersion path.

### CROSS-REFERENCE TO RELATED APPLICATION(S)

This application claims the benefit under 35 U.S.C. §119(a) of a Korean patent application filed on Aug. 22, 2014 in the Korean Intellectual Property Office and assigned Serial number 10-2014-0109437, the entire disclosure of which is hereby incorporated by reference.

### TECHNICAL FIELD

The present disclosure relates to a multiband antenna capable of adjusting a specific absorption rate (SAR).

### BACKGROUND

With the advancement of information communications technologies, network devices, such as a base station, and the like, may be installed to support data communication. An electronic device may transmit and receive data to and from any other electronic device through a network device, thereby allowing a user to use network devices anywhere.

The energy of electromagnetic waves may be radiated when an electronic device transmits and receives data. Electromagnetic waves absorbed in a human body may be bad for the human body. For this reason, each nation may have a specific absorption rate (SAR) standard and may prevent dispersion of electronic products of which the SAR exceeds a certain level.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device capable of adjusting a specific absorption rate (SAR).

In accordance with an aspect of the present disclosure, a multiband antenna is provided. The multiband antenna includes a feeding unit, a first radiator including a first path, a second radiator including a second path sharing at least a portion of the first path, a current dispersion path extending to a ground from one end of the first path, and a switch configured to open and short-circuit the current dispersion path.

In accordance with another aspect of the present disclosure, an electronic device is provided. The electronic device includes a multiband antenna, a memory, and at least one processor electrically connected to the multiband antenna and the memory. The multiband antenna includes a feeding unit, a first radiator including a first path, a second radiator including a second path sharing at least a portion of the first path, a current dispersion path extending to a ground from one end of the first path, and a switch configured to open and short-circuit the current dispersion path.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram schematically illustrating a monopole multiband antenna and a current flow of the monopole multiband antenna according to various embodiments of the present disclosure;

FIGS. 2A and 2B are diagrams schematically illustrating a monopole multiband antenna, a current dispersion path extending from one end of the monopole multiband antenna, and a switch placed on the current dispersion path according to various embodiments of the present disclosure;

FIG. 3 is a diagram schematically illustrating a planar inverted F antenna (PIFA) multiband antenna and a current flow of the PIFA multiband antenna according to various embodiments of the present disclosure;

FIGS. 4A and 4B are diagrams schematically illustrating a PIFA multiband antenna, a current dispersion path extending from one end of the PIFA multiband antenna, and a switch placed on the current dispersion path according to various embodiments of the present disclosure;

FIG. 5 is a diagram schematically illustrating an electronic device including a multiband antenna according to various embodiments of the present disclosure; and

FIG. 6 is a diagram schematically illustrating a current dispersion operation of a multiband antenna corresponding to a metal housing according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The terms “include,” “comprise,” “including,” or “comprising” used herein indicate disclosed functions, operations, or existence of elements but does not exclude other functions, operations or elements. It should be further understood that the term “include”, “comprise”, “have”, “including”, “comprising”, or “having” used herein specifies the presence of stated features, integers, operations, elements, components, or combinations thereof but does not preclude the presence or addition of one or more other features, integers, operations, elements, components, or combinations thereof.

The meaning of the term “or” or “at least one of A and/or B” used herein includes any combination of words listed together with the term. For example, the expression “A or B” or “at least one of A and/or B” may indicate A, B, or both A and B.

The terms, such as “first”, “second”, and the like used herein may refer to various elements of various embodiments of the present disclosure, but do not limit the elements. For example, such terms do not limit the order and/or priority of the elements. Furthermore, such terms may be used to distinguish one element from another element. For example, “a first user device” and “a second user device” indicate different user devices. For example, without departing the scope of the present disclosure, a first element may be referred to as a second element, and similarly, a second element may be referred to as a first element.

In the description below, when one part (or element, device, and the like) is referred to as being “connected” to another part (or element, device, and the like), it should be understood that the former can be “directly connected” to the latter, or “electrically connected” to the latter via an intervening part (or element, device, and the like). It will be further understood that when one component is referred to as being “directly connected” or “directly linked” to another component, it indicates that no intervening component is present.

Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal sense unless expressly so defined herein in various embodiments of the present disclosure.

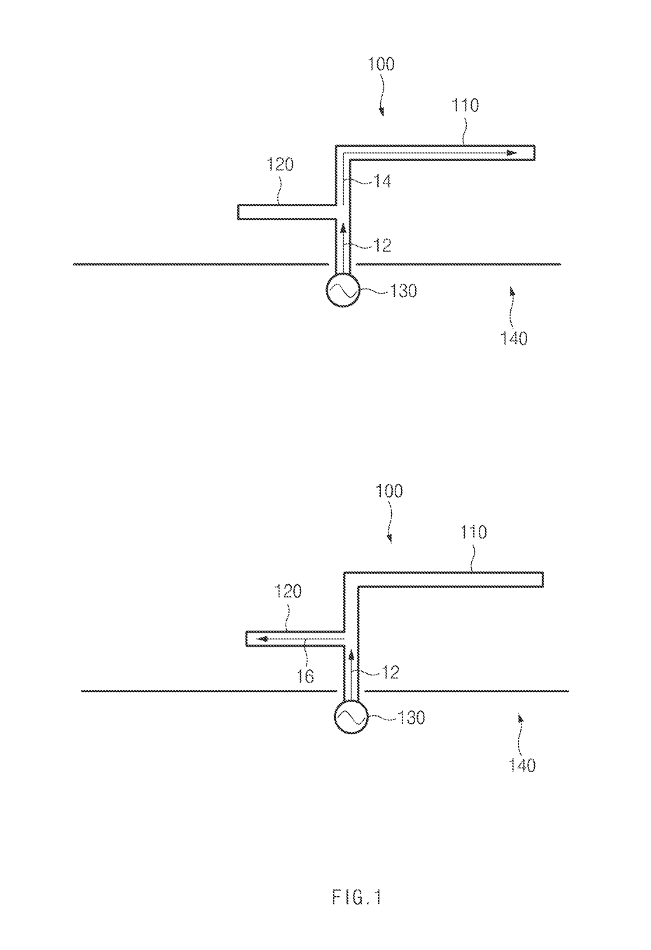

Electronic devices according to various embodiments of the present disclosure may be a device including a multiband antenna for adjusting a specific absorption rate (SAR), which will be described with reference to FIGS. 1 to 6. For example, the electronic devices may include at least one of smartphones, tablet personal computers (PCs), mobile phones, video telephones, electronic book readers, desktop PCs, laptop PCs, netbook computers, personal digital assistants (PDAs), portable multimedia players (PMPs), Moving Picture Experts Group 1 or 2 (MPEG-1 or MPEG-2) audio layer 3 (MP3) players, mobile medical devices, cameras, wearable devices (e.g., head-mounted-devices (HMDs), such as electronic glasses), an electronic apparel, electronic bracelets, electronic necklaces, electronic appcessories, electronic tattoos, smart watches, and the like.

According to various embodiments of the present disclosure, the electronic devices may be smart home appliances including a multiband antenna for adjusting an SAR. The smart home appliances may include at least one of, for example, televisions (TVs), digital versatile disc (DVD) players, audios, refrigerators, air conditioners, cleaners, ovens, microwave ovens, washing machines, air cleaners, set-top boxes, TV boxes (e.g., Samsung HomeSync™, Apple TV™, or Google TV™), game consoles, electronic dictionaries, electronic keys, camcorders, electronic picture frames, and the like.

Furthermore, an electronic device according to various embodiments of the present disclosure may be a flexible device including a multiband antenna for adjusting an SAR. However, an electronic device according to various embodiments of the present disclosure may not be limited to the above-described devices.

Hereinafter, an electronic device according to various embodiments of the present disclosure will be described with reference to FIGS. 1 to 6. The term “user” used herein may refer to a person who uses an electronic device or may refer to a device (e.g., an artificial electronic device) that uses an electronic device.

FIG. 1 is a diagram schematically illustrating a monopole multiband antenna and a current flow of the monopole multiband antenna according to various embodiments of the present disclosure.

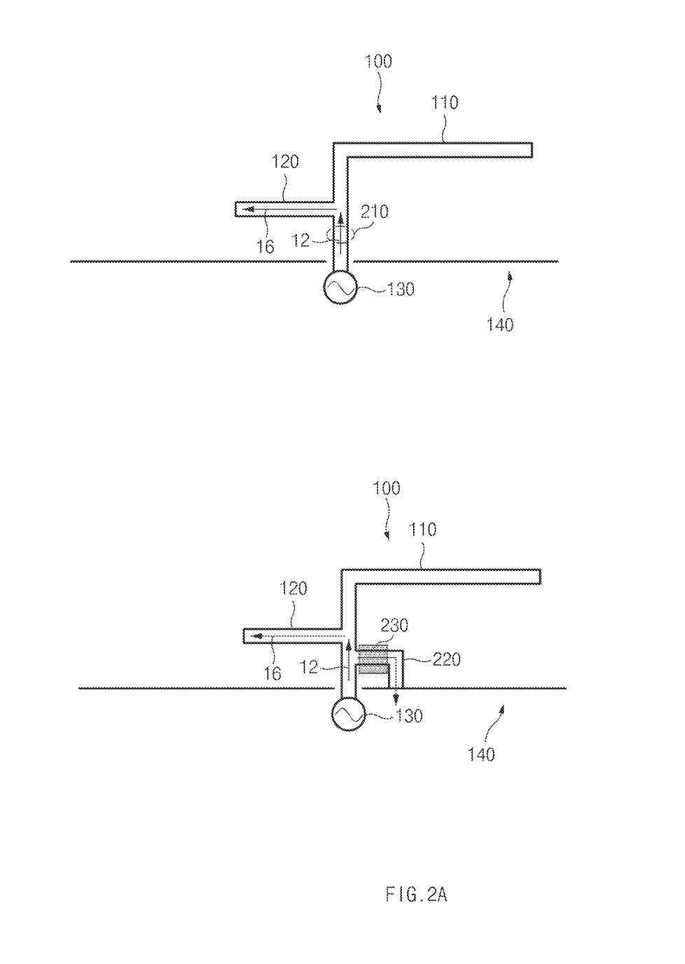

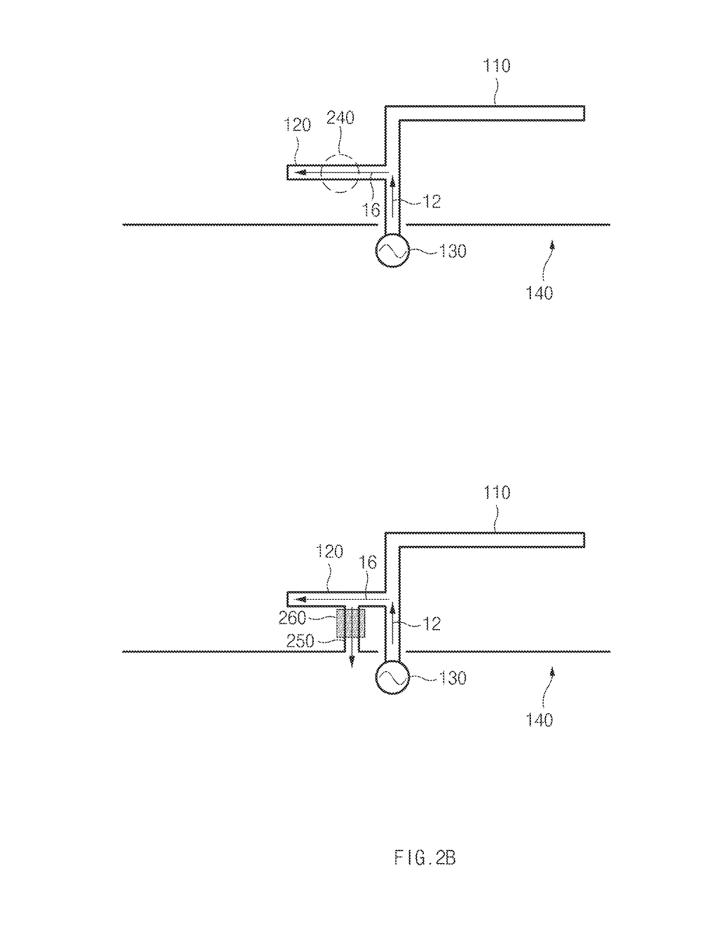

Referring to FIG. 1, a monopole multiband antenna 100 may include a first radiator 110, a second radiator 120, and a feeding unit 130. A ground area 140 illustrated in FIG. 1 will be described with reference to FIGS. 2A and 2B.

The first radiator 110 and the second radiator 120 may operate in different frequency bands. For example, the first radiator 110 may operate in a lower band of 700 MHz to 900 MHz, and the second radiator 120 may operate in an upper band of 1400 MHz to 2700 MHz. According to various embodiments of the present disclosure, an embodiment of the present disclosure will be exemplified as the first radiator 110 and the second radiator 120 do not operate at the same time.

A drawing illustrated at the top of FIG. 1 illustrates a current flow when the first radiator 110 operates. The first radiator 110 may include a first path 12 and a second path 14. A current for an operation of the first radiator 110 may flow, for example, through the first path 12 and the second path 14 from the feeding unit 130, thereby making it possible for the first radiator 110 to operate.

A drawing illustrated at the bottom of FIG. 1 illustrates a current flow when the second radiator 120 operates. The second radiator 120 may include the first path 12 and a third path 16. A current for an operation of the second radiator 120 may flow, for example, through the first path 12 and the third path 16 from the feeding unit 130, thereby making it possible for the second radiator 120 to operate.

In an operation of the first radiator 110 or the second radiator 120, a strong current dispersion on a narrow area may cause a high SAR value. In this case, the SAR value may be lowered by changing a structure of the multiband antenna 100, but the throughput of communications may be reduced due to the changed structure. A multiband antenna according to various embodiments of the present disclosure may have a current dispersion path at an area where a high SAR value is generated. In this case, the SAR value may be lowered because a current of a corresponding area is dispersed. Below, a multiband antenna including a current dispersion path will be described with reference to FIGS. 2A and 2B.

FIGS. 2A and 2B are diagrams schematically illustrating a monopole multiband antenna, a current dispersion path extending from one end of the monopole multiband antenna, and a switch placed on the current dispersion path according to various embodiments of the present disclosure.

Referring to FIG. 2A, a drawing illustrated at the top of FIG. 2A illustrates the case that a second radiator 120 of a monopole multiband antenna 100 illustrated in FIG. 1 operates. According to various embodiments of the present disclosure, a current may be focused on a first path 12 shared by a first radiator 110 and a second radiator 120. For example, an area 210 of the monopole multiband antenna 100 illustrated at the top of FIG. 2A may be an area of which the high SAR is measured due to a focused current. Below, a description on the monopole multiband antenna 100 duplicated with that described with reference to FIG. 1 may be omitted.

Referring to a drawing illustrated at the bottom of FIG. 2A, the monopole multiband antenna 100 according to various embodiments of the present disclosure may include a current dispersion path 220 extending from the area 210 and a switch 230 placed on the current dispersion path 220.

The current dispersion path 220 may be implemented at the monopole multiband antenna 100 in such a way that the current dispersion path 220 extends from the area 210 to a ground area 140. The current dispersion path 220 may allow at least a portion of a current focused on the area 210 to flow in the ground area 140 along the current dispersion path 220. For example, a portion of a current flowing into the first path 12 may flow into the ground area 140 through the current dispersion path 220, thereby reducing the amount of current staying at the area 210. This may indicate that an SAR value measured at the area 210 is lowered.

The switch 230 may open and short-circuit the current dispersion path 220. For example, the switch 230 may short-circuit the current dispersion path 220 in the case of distributing a current focused on the area 210 and may open the current dispersion path 220 in the case of not distributing a current focused on the area 210. Since the switch 230 corresponds to (or is associated with) the case that the second radiator 120 operates, the switch 230 may be short-circuited (or turned on) if the second radiator 120 operates and may be opened (or turned off) if the first radiator 110 operates. Furthermore, since the SAR is restricted in the light of an influence on a human body, the switch 230 may be short-circuited if the human body is close to the monopole multiband antenna 100 (or a portion of the monopole multiband antenna 100) and may be opened if the human body is not close to the monopole multiband antenna 100 (or a portion of the monopole multiband antenna 100).

According to various embodiments of the present disclosure, the switch 230 may receive a signal for opening or short-circuiting the current dispersion path 220 from an external device and may open or short-circuit the current dispersion path 220. The signal may be received from a processor or a communication processor (CP) of an electronic device including the monopole multiband antenna 100.

In FIG. 2A, an embodiment of the present disclosure is exemplified as the area 210 on which a current is focused is illustrated on the first path 12 shared by the first radiator 110 and the second radiator 120. However, a current-focused area may not be limited to the first path 12. According to various embodiments of the present disclosure, a current-focused area may be placed on a second path 14 or a third path 16 which is not shared by the first radiator 110 and the second radiator 120. Below, the case that a current-focused area is placed on the third path 16 which is not shared by the first radiator 110 and the second radiator 120 will be described with reference to FIG. 2B. Although not illustrated in FIG. 2B, the case that a current-focused area is placed on the second path 14 may be also similar thereto.

Referring to FIG. 2B, a drawing illustrated at the top of FIG. 2B illustrates the case that the second radiator 120 of the monopole multiband antenna 100 illustrated in FIG. 1 operates. Similarly to a description given with reference to FIG. 2A, an area 240 of the monopole multiband antenna 100 illustrated in FIG. 2B may be an area of which the high SAR is measured due to a focused current.

According to various embodiments of the present disclosure, the monopole multiband antenna 100 may include a current dispersion path 250 extending from the area 240 and a switch 260 placed on the current dispersion path 250.

The current dispersion path 250 may be implemented at the monopole multiband antenna 100 in such a way that the current dispersion path 250 extends from the area 240 to the ground area 140. The current dispersion path 250 may allow at least a portion of a current focused on the area 240 to flow in the ground area 140 along the current dispersion path 250. For example, a portion of a current flowing through the first path 12 and the third path 16 may flow into the ground area 140 through the current dispersion path 250, thereby reducing the amount of current staying at the area 240. This may indicate that an SAR value measured at the area 240 is lowered.

Similarly to a description described with reference to FIG. 2A, the switch 260 may open or short-circuit the current dispersion path 250. The switch 260 may open or short-circuit the current dispersion path 250 in response to a signal (or a command) from an external device.

According to various embodiments of the present disclosure, the monopole multiband antenna 100 may include both the current dispersion path 220 and the switch 230 and the current dispersion path 250 and the switch 260. For example, since a current is focused on the area 240 as well as the area 210, a high SAR value may be measured.

Described with reference to FIGS. 2A and 2B is a method for distributing a current of the current-focused area 210 or 240 when the second radiator 120 operates. A current may be focused similarly even when the first radiator 110 operates. Accordingly, the above-described current distributing method may not be limited to the case that the second radiator 120 operates, and the above-described current distributing method may be also applied to the case that the first radiator 110 operates.

Furthermore, the monopole multiband antenna 100 may include both a current dispersion path and a switch, which are capable of lowering a high SAR value caused when the first radiator 110 operates, and a current dispersion path and a switch, which are capable of lowering a high SAR value caused when the second radiator 120 operates.

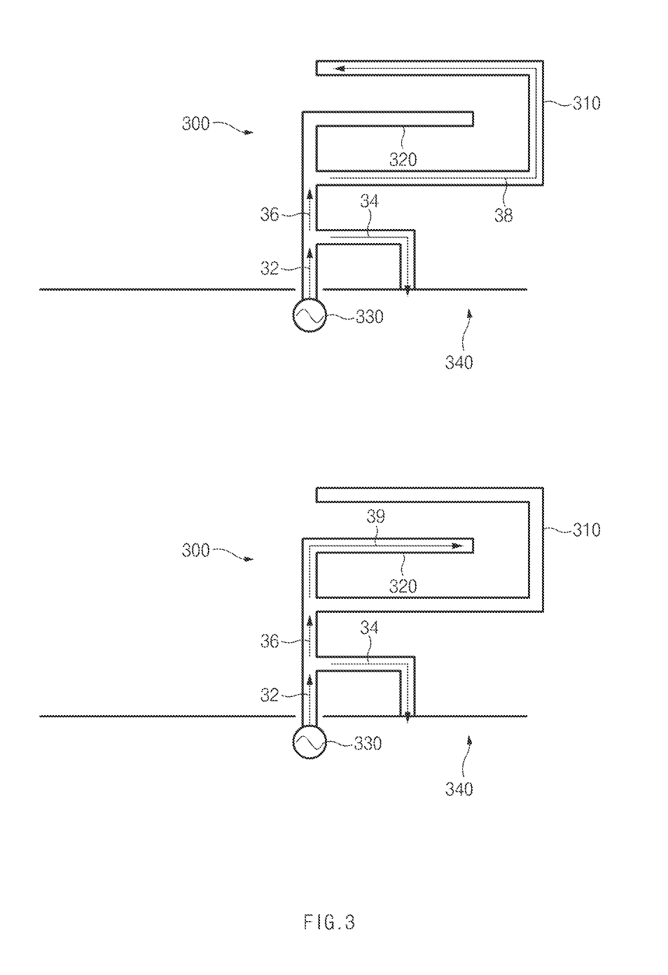

FIG. 3 is a diagram schematically illustrating a planar inverted F antenna (PIFA) multiband antenna and a current flow of the PIFA multiband antenna according to various embodiments of the present disclosure.

Referring to FIG. 3, a PIFA multiband antenna 300 may include a first radiator 310, a second radiator 320, and a feeding unit 330.

Similarly to a monopole multiband antenna 100 of FIG. 1, the first radiator 310 and the second radiator 320 may operate in different frequency bands, respectively. An embodiment of the present disclosure will be described under the assumption that the first radiator 310 and the second radiator 320 do not operate at the same time.

A drawing illustrated at the top of FIG. 3 illustrates a current flow when the first radiator 310 operates. The first radiator 310 may include a first path 32, a second path 34, a third path 36, and a fourth path 38. The first radiator 310 may operate according to flows of a first current and a second current. For example, the first current may be a current flowing in a ground area 340 from the feeding unit 330 through the first path 32 and the second path 34, and the second current may be a current flowing from the feeding unit 330 through the first path 32, the third path 36, and the fourth path 38.

A drawing illustrated at the bottom of FIG. 3 illustrates a current flow when the second radiator 320 operates. The second radiator 320 may include the first path 32, the second path 34, the third path 36, and a fifth path 39. The second radiator 320 may operate according to flows of the first current and a third current. As described above, the first current may be a current flowing in the ground area 340 from the feeding unit 330 through the first path 32 and the second path 34, and the third current may be a current flowing from the feeding unit 330 through the first path 32, the third path 36, and the fifth path 39.

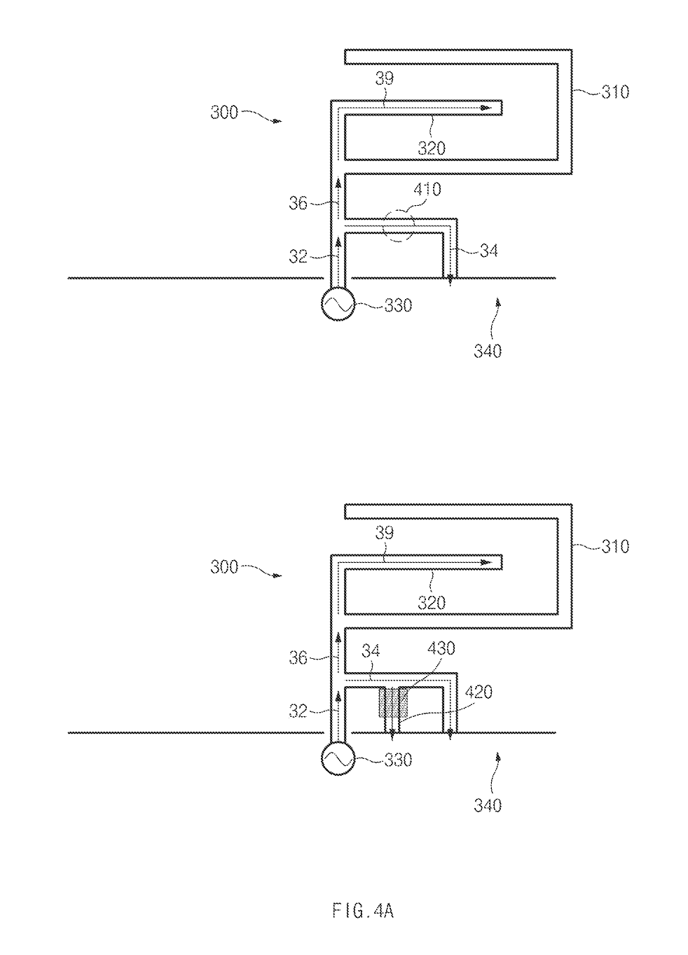

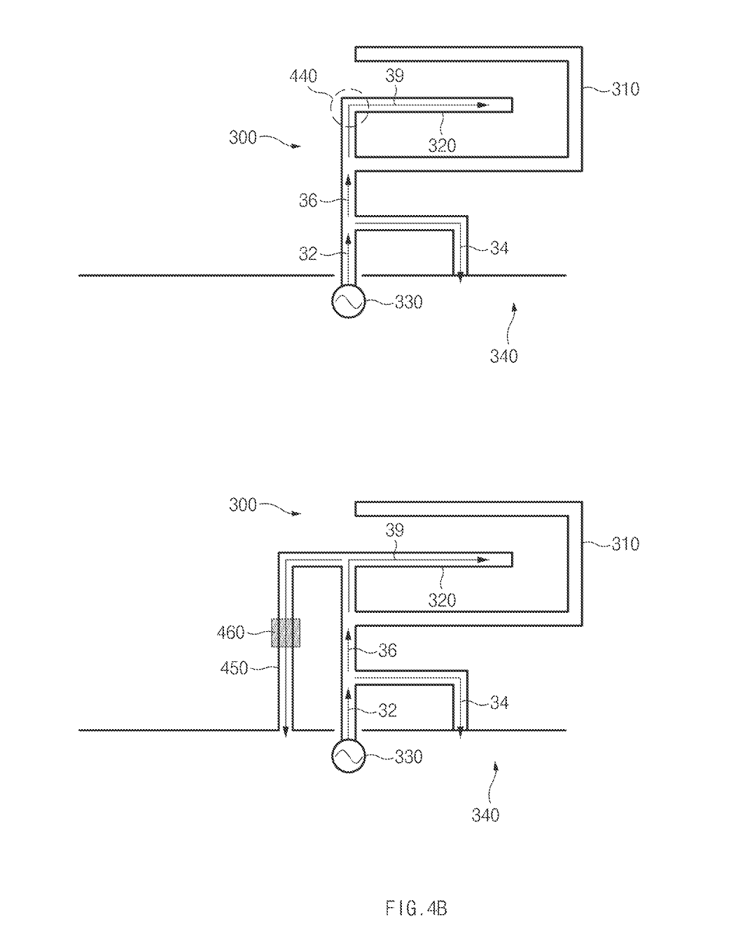

Similarly to the monopole multiband antenna 100 of FIG. 2A, in an operation of the first radiator 310 or the second radiator 320 of the PIFA multiband antenna 300, a strong current dispersion on a narrow area may cause a high SAR value. Below, there will be described the PIFA multiband antenna 300, which includes a current dispersion path and a switch to reduce an SAR with reference to FIGS. 4A and 4B.

FIGS. 4A and 4B are diagrams schematically illustrating a PIFA multiband antenna, a current dispersion path extending from one end of PIFA multiband antennas, and a switch placed on the current dispersion path according to various embodiments of the present disclosure.

Referring to FIG. 4A, a drawing illustrated at the top of FIG. 4A illustrates the case that a second radiator 320 of a PIFA multiband antenna 300 illustrated in FIG. 3 operates. According to various embodiments of the present disclosure, a current may be focused on a second path 34 shared by a first radiator 310 and a second radiator 320. For example, an area 410 of the PIFA multiband antenna 300 illustrated at the top of FIG. 4A may be an area of which the high SAR is measured due to a focused current. Below, a description on the PIFA multiband antenna 300 duplicated with that described with reference to FIG. 3 may be omitted.

Referring to a drawing illustrated at the bottom of FIG. 4A, the PIFA multiband antenna 300 according to various embodiments of the present disclosure may include a current dispersion path 420 extending from the area 410 and a switch 430 placed on the current dispersion path 420.

The current dispersion path 420 may be implemented at the PIFA multiband antenna 300 in such a way that the current dispersion path 420 extends from the area 410 to a ground area 340. The current dispersion path 420 may allow at least a portion of a current focused on the area 410 to flow in the ground area 440 along the current dispersion path 420. Accordingly, since the amount of current staying at the area 210 is reduced, an SAR value of the area 410 may be lowered.

The switch 430 may open and short-circuit the current dispersion path 420. For example, the switch 430 may short-circuit the current dispersion path 420 in the case of distributing a current focused on the area 410 and may open the current dispersion path 420 in the case of not distributing a current focused on the area 410. Since the switch 430 corresponds to (or is associated with) the case that the second radiator 320 operates, the switch 430 may be short-circuited if the second radiator 320 operates and may be opened if the first radiator 310 operates.

According to various embodiments of the present disclosure, the switch 430 may receive a signal for opening or short-circuiting the current dispersion path 420 from an external device and may open or short-circuit the current dispersion path 420 based on the received signal. The signal may be received from a processor or a CP of an electronic device including the PIFA multiband antenna 300.

In FIG. 4A, an embodiment of the present disclosure is exemplified as the area 410 on which a current is focused is illustrated on the second path 34 shared by the first radiator 310 and the second radiator 320. However, a current-focused area may not be limited to an area shared by the first radiator 310 and the second radiator 320. According to various embodiments of the present disclosure, a current-focused area may be placed on a fourth path 38 or a fifth path 39 which are not shared by the first radiator 310 and the second radiator 320. Below, the case that a current-focused area is placed on the fourth path 38 or the fifth path 39 which are not shared by the first radiator 310 and the second radiator 320 will be described with reference to FIG. 4B.

Referring to FIG. 4B, a drawing illustrated at the top of FIG. 4B illustrates the case that the second radiator 320 of the PIFA multiband antenna 300 illustrated in FIG. 1 operates. Similarly to a description given with reference to FIG. 4A, an area 440 of the PIFA multiband antenna 300 illustrated in FIG. 4B may be an area of which the high SAR is measured due to a focused current.

According to various embodiments of the present disclosure, the PIFA multiband antenna 300 may include a current dispersion path 450 extending from the area 440 and a switch 460 placed on the current dispersion path 450.

The current dispersion path 450 may be implemented at the PIFA multiband antenna 300 in such a way that the current dispersion path 450 extends from the area 440 to the ground area 340. The current dispersion path 450 may allow at least a portion of a current focused on the area 440 to flow in the ground area 340 along the current dispersion path 450. For example, a portion of a current flowing through the first path 32, the third path 36, and the fifth path 39 may flow into the ground area 340 through the current dispersion path 450, thereby reducing the amount of current staying at the area 440. This may indicate that an SAR value measured at the area 440 is lowered.

Similarly to a description described with reference to FIG. 4A, the switch 460 may open or short-circuit the current dispersion path 450. The switch 460 may open or short-circuit the current dispersion path 450 in response to a signal (or a command) from an external device.

A method for distributing a current a current-focused area 410 or 440 when the second radiator 320 operates is described with reference to FIGS. 4A and 4B. A current may be focused similarly even when the first radiator 310 operates. Accordingly, the above-described current distributing method may not be limited to the case that the second radiator 320 operates, and the above-described current distributing method may be also applied to the case that the first radiator 310 operates.

Furthermore, the PIFA multiband antenna 300 may include at least one or more current dispersion paths and at least one or more switches to disperse a current, that is, a plurality of current dispersion paths and a plurality of switches.

A monopole multiband antenna 100 and a PIFA multiband antenna 300 are exemplified in FIGS. 1 to 4B as being multiband antennas. According to various embodiments of the present disclosure, a multiband antenna may have various shapes. For example, the multiband antenna may be a dipole multiband antenna, a patch multiband antenna, and the like. Furthermore, at least a portion of the multiband antenna may be formed of at least a portion of a metal housing included in an electronic device.

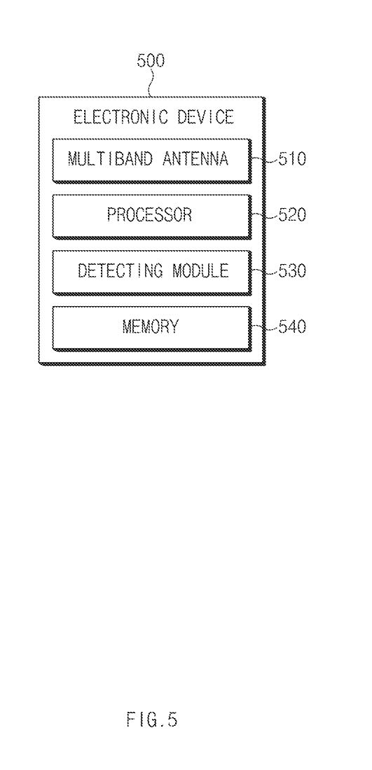

FIG. 5 is a diagram schematically illustrating an electronic device including a multiband antenna according to various embodiments of the present disclosure.

Referring to FIG. 5, an electronic device 500 may include a multiband antenna 510, a processor 520, a detecting module 530, and a memory 540. The electronic device 500 illustrated in FIG. 5 may be variously modified or changed based on components illustrated in FIG. 5. For example, the electronic device 500 may further include the following user interfaces for receiving any command or information from a user: a keyboard, a mouse, and the like.

The multiband antenna 510 may include a monopole multiband antenna 100 or a PIFA multiband antenna 300 described with reference to FIGS. 1 to 4B. Furthermore, the multiband antenna 510 may include a current dispersion path and a switch at a current-focused area to disperse a focused current, thereby reducing an SAR. In this case, the switch may close and short-circuit the current dispersion path to disperse a focused current. The multiband antenna 510 may include a first current dispersion path and a first switch, which are configured to disperse a current focused in operating in a first frequency band, and a first current dispersion path and a first switch, which are configured to disperse a current focused in operating in a second frequency band.

The processor 520 may include an application processor (AP) or a CP. The processor 520 may control a switch included in the multiband antenna 510. For example, in the case where the multiband antenna 510 operates in the first frequency band, the processor 520 may generate a signal for turning on the first switch and turning off the second switch and may transmit the signal to the first switch and the second switch. In contrast, in the case where the multiband antenna 510 operates in the second frequency band, the processor 520 may generate a signal for turning off the first switch and turning on the second switch and may transmit the signal to the first switch and the second switch.

According to various embodiments of the present disclosure, the processor 520 may simply provide information of a frequency band currently used or to be used to the first switch and the second switch. In this case, the first switch and the second switch may receive the information of the frequency band and may be turned on or off in response to the information of the frequency band. For example, if receiving information on the first frequency band, the first switch may short-circuit a first current dispersion path. In contrast, if receiving information on the second frequency band, the first switch may open the first current dispersion path. An operation of the second switch according to received frequency band information may be reverse to that of the first switch.

The processor 520 which generates a command to be transmitted to the first switch and the second switch may be an AP, but the processor 520 which simply transmits frequency band information to the first switch and the second switch may be a CP.

The detecting module 530 may detect whether a human body approaches to the electronic device 500. The detecting module 540 may detect a human body using a gesture sensor, an approximate sensor, a living body sensor, an infrared (IR) sensor, and the like.

If a human body approaches to the electronic device 500, the processor 520 may generate a signal for turning on the first switch or the second switch and may transmit the signal to the first switch or the second switch.

The memory 540 may store data. Data stored at the memory 540 may include data exchanged between components of the electronic device 500 and may include data exchanged between the electronic device 500 and external components of the electronic device 500. For example, the memory 540 may store information on a first frequency band or a second frequency band in which the electronic device 500 operates. The memory 540 may also store information for determining whether a human body approaches to the electronic device 500, based on information that the processor 520 collects through the detecting module 530. The memory 540 may be formed of, for example, a hard disk drive, a read only memory (ROM), a random access memory (RAM), a flash memory, a memory card, and the like existing inside or outside the electronic device 500.

It may be understood that the multiband antenna 510, the processor 520, the detecting module 530, and the memory 540 are implemented independently of each other or two or more components thereof are integrated.

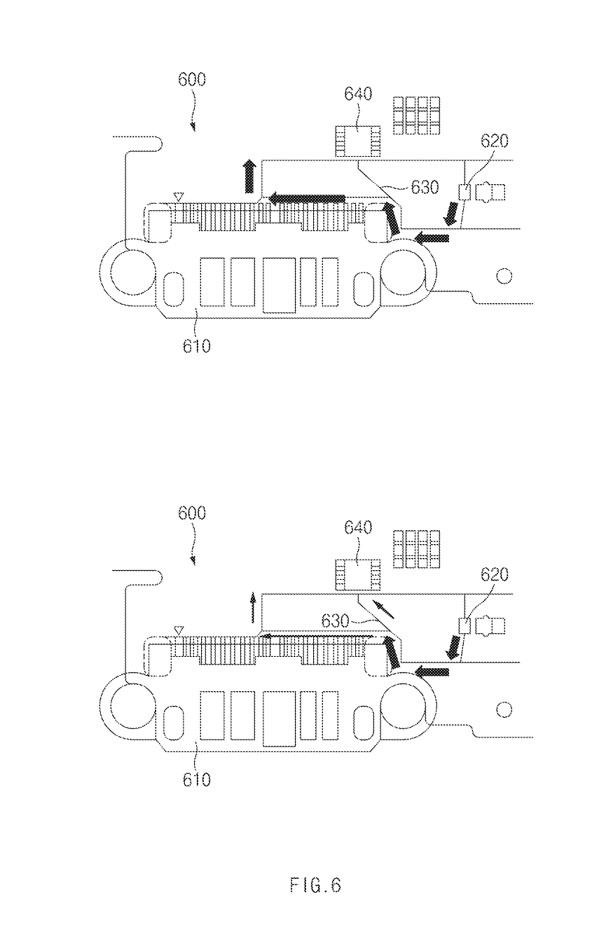

FIG. 6 is a diagram schematically illustrating a current dispersion operation of a multiband antenna corresponding to a metal housing according to various embodiments of the present disclosure.

Referring to FIG. 6, a multiband antenna 600 may include at least a portion of a housing 610, a feeding unit 620, a current dispersion path 630, and a switch 640. The housing 610 illustrated in FIG. 6 may be a universal serial bus (USB) connector, a high definition multimedia interface (HDMI) connector, a recommended standard 232 (RS-232) connector, a plain old telephone service (POTS) connector, and the like. According to various embodiments of the present disclosure, the housing 610 may be implemented with a shield can, stacked on an electronic part mounted at a printed circuit board (PCB), as well as various types of connectors.

In a drawing illustrated at the top of FIG. 6, arrows may indicate a current flow in the case where the switch 640 opens a current dispersion path 630. In a drawing illustrated at the bottom of FIG. 6, arrows may indicate a current flow in the case where the switch 640 short-circuits the current dispersion path 630. A thickness of each arrow indicating a current flow may indicate the amount of current.

A drawing illustrated at the top of FIG. 6 and a drawing illustrated at the bottom of FIG. 6 will be compared. In a drawing illustrated at the top of FIG. 6, a current flowing in the feeding unit 620 may flow along a line without flowing into the current dispersion path 630. In contrast, in a drawing illustrated at the bottom of FIG. 6, at least a portion of a current flowing into the feeding unit 620 may flow into the current dispersion path 630. This may indicate that the flowing into the feeding unit 620 is dispersed. Accordingly, the amount of current flowing through the current dispersion path 630 may be smaller than the amount of current flowing into the current dispersion path 630.

According to various embodiments of the present disclosure, a multiband antenna may include a feeding unit, a first radiator including a first path, a second radiator including a second path sharing at least a portion of the first path, a current dispersion path extending to a ground from one end of the first path, and a switch configured to open and short-circuit the current dispersion path.

According to various embodiments of the present disclosure, the switch may be short-circuited if the first radiator operates and may be opened if the second radiator operates. For example, the short-circuited switch may allow at least a portion of a current, flowing from the feeding unit through the first path, to flow through the current dispersion path from the one end of the first path.

According to various embodiments of the present disclosure, the switch may receive a signal for opening and short-circuiting the current dispersion path from an external device and may open and short-circuit the current dispersion path based on the received signal.

According to various embodiments of the present disclosure, the first and second radiators may operate in different frequency bands from each other.

According to various embodiments of the present disclosure, the one end of the first path from which the current dispersion path extends to the ground may be placed at an area at which the first path and the second path are shared. Unlikely, according to various embodiments of the present disclosure, the one end of the first path from which the current dispersion path extends to the ground may be placed on an area of the first path at which the first path and the second path are not shared.

According to various embodiments of the present disclosure, the multiband antenna may further include a second current dispersion path extending to the ground from one end of the second path and a second switch configured to open and short-circuit the second current dispersion path.

According to various embodiments of the present disclosure, the first radiator or the second radiator may correspond to a monopole antenna or a PIFA antenna.

According to various embodiments of the present disclosure, at least a portion of the first radiator or the second radiator may be formed of at least a portion of a metal housing.

According to various embodiments of the present disclosure, the switch may be turned on if a human body approaches thereto and may be turned off if the human body does not approach thereto.

According to various embodiments of the present disclosure, an electronic device may include a multiband antenna, a memory, and at least one processor electrically connected to the multiband antenna and the memory. The multiband antenna may include a feeding unit, a first radiator including a first path, a second radiator including a second path sharing at least a portion of the first path, a current dispersion path extending to a ground from one end of the first path, and a switch configured to open and short-circuit the current dispersion path.

According to various embodiments of the present disclosure, the processor may generate a control signal for controlling the switch and may transfer the generated control signal to the switch.

According to various embodiments of the present disclosure, the control signal may turn on the switch if the first radiator operates and may turn off the switch if the second radiator operates.

According to various embodiments of the present disclosure, the electronic device may further include a detecting module configured to detect a human body approaching to the electronic device, and the control signal may turn on the switch if the human body is detected by the detecting module and may turn off the switch if the human body is not detected by the detecting module.

Each of the above-mentioned elements of the electronic device according to various embodiments of the present disclosure may be configured with one or more components, and the names of the elements may be changed according to the type of the electronic device. The electronic device according to various embodiments of the present disclosure may include at least one of the above-mentioned elements, and some elements may be omitted or other additional elements may be added. Furthermore, some of the elements of the electronic device according to various embodiments of the present disclosure may be combined with each other so as to form one entity, so that the functions of the elements may be performed in the same manner as before the combination.

The term “module” used herein may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed.

At least a portion of an apparatus (e.g., modules or functions thereof) or a method (e.g., operations) according to various embodiments of the present disclosure may be, for example, implemented by instructions stored in a computer-readable storage media in the form of a programmable module. The instruction, when executed by one or more processors (e.g., the processor 520), may cause the one or more processors to perform a function corresponding to the instruction. The computer-readable storage media, for example, may be the memory 540. At least a portion of the programming module may be implemented (e.g., executed), for example, by the processor 520. At least a portion of the programming module may include, for example, modules, programs, routines, sets of instructions, or processes, and the like, for performing one or more functions.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

A module or a programming module according to an embodiment of the present disclosure may include at least one of the above elements, or a portion of the above elements may be omitted, or additional other elements may be further included. Operations performed by a module, a program module, or other elements according to an embodiment of the present disclosure may be executed sequentially, in parallel, repeatedly, or in a heuristic method. In addition, a portion of operations may be executed in different sequences, omitted, or other operations may be added.

According to various embodiments of the present disclosure, a multiband antenna may adjust an SAR, thereby reducing a harmful influence on a human body.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A multiband antenna comprising:
a feeding unit;
a first radiator including a first path;
a second radiator including a second path sharing at least a portion of the first path;
a current dispersion path extending to a ground from one end of the first path; and
a switch configured to open and short-circuit the current dispersion path.

2. The multiband antenna of claim 1,
wherein the switch is short-circuited, if the first radiator operates to short-circuit the current dispersion path, and
wherein the switch is opened, if the second radiator operates to open the current dispersion path.

3. The multiband antenna of claim 2, wherein, when short-circuited, the switch allows at least a portion of a current, flowing from the feeding unit through the first path, to flow through the current dispersion path from the one end of the first path.

4. The multiband antenna of claim 2, wherein the switch receives a signal for opening and short-circuiting the current dispersion path from an external device and opens and short-circuits the current dispersion path based on the received signal.

5. The multiband antenna of claim 1, wherein the first and second radiators operate in different frequency bands from each other.

6. The multiband antenna of claim 1, wherein the one end of the first path is placed at an area at which the first path and the second path are shared.

7. The multiband antenna of claim 1, wherein the one end of the first path is placed on an area of the first path at which the first path and the second path are not shared.

8. The multiband antenna of claim 1, further comprising:
a second current dispersion path extending to the ground from one end of the second path; and
a second switch configured to open and short-circuit the second current dispersion path.

9. The multiband antenna of claim 1, wherein the first radiator or the second radiator corresponds to a monopole antenna or a planar inverted F antenna (PIFA) antenna.

10. The multiband antenna of claim 1, wherein at least a portion of the first radiator or the second radiator comprises at least a portion of a metal housing.

11. The multiband antenna of claim 1,
wherein the switch is short-circuited, if a human body approaches thereto, and
wherein the switch is opened, if the human body does not approach thereto.

12. An electronic device comprising:
a multiband antenna;
a memory; and
at least one processor electrically connected to the multiband antenna and the memory,
wherein the multiband antenna comprises:
a feeding unit;
a first radiator including a first path;
a second radiator including a second path sharing at least a portion of the first path;
a current dispersion path extending to a ground from one end of the first path; and
a switch configured to open and short-circuit the current dispersion path.

13. The electronic device of claim 12, wherein the at least one processor is configured to:
generate a control signal for controlling the switch, and
transfer the generated control signal to the switch.

14. The electronic device of claim 13,
wherein the control signal turns on the switch, if the first radiator operates, and
wherein the control signal turns off the switch, if the second radiator operates.

15. The electronic device of claim 13, further comprising:
a detecting module configured to detect a human body approaching to the electronic device,
wherein the control signal turns on the switch, if the human body is detected by the detecting module, and
wherein the control signal turns off the switch, if the human body is not detected by the detecting module.
